(19) United States
(12) Patent Application Publication
(10) Pub. No.: US 2004/0025816 A1
(43) Pub. Date: Feb. 12, 2004

(54) Two-stroke cycle for internal combustion engines

(76) Inventor: Drazen Paut, Split (HR)

Correspondence Address: JACOBSON HOLMAN PLLC, 400 SEVENTH STREET N.W., SUITE 600, WASHINGTON, DC, 20004, US

(21) Appl. No.: 10/380,164

(22) PCT Filed: Sep. 14, 2001
(86) PCT No.: PCT/HR01/00041

(30) Foreign Application Priority Data
Sep. 22, 2000 (HR) P20000632A

(51) Int. Cl. F02B 33/10; F02B 33/20; F02B 33/22

(52) U.S. Cl. 123/70 R; 123/71 R; 123/72

(57) ABSTRACT

This two-stroke cycle is applicable at classical internal combustion engines (piston-rod-crankshaft) as well as at engines with two-sided piston. The very systems has at least one pair of cylinders (1, 2) of which one (1) is compresor (pump) and other (2) is engine. The compressor and the engine pistons (3, 4) have such phase delay to each other that when one piston is in the midpoint between two “dead points” of the engine, other is in one of “dead points”. At the moment when the compressor piston (3) has passed half the way from LDP to UDP, it also has precompressed the sucked air, while the engine piston (4) is at LDP and has opened the exhausting channel (15), which leaves out the combustion gas. Because of the higher pressure in the compressing pipe relating to the pressure in engine cylinder (2), the inlet valve (7) of the engine opens and fresh air enters the engine. When the compressor piston (3) comes at UDP, it delivers all the air to the engine and spring force closes the inlet valve (7) of the engine. In the meantime the engine piston (4) has closed the exhausting channel (15) and the injector (11) has injected the fuel into the engine cylinder (2). The engine piston (4) keeps on compressing the air-fuel compound until the UDP has reached. The sparking plug (13) starts the ignition, while the compressor piston (3) goes towards LDP sucking the air. The cycle is repeating.

### TECHNICAL FIELD

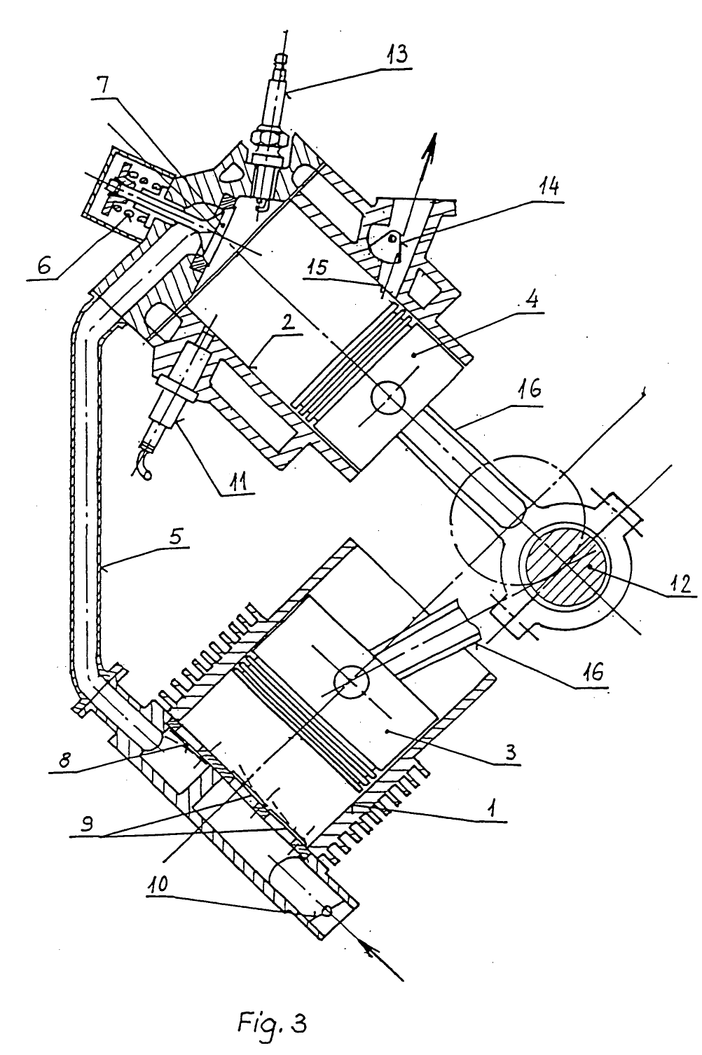

Classical piston engines (piston-rod-crankshaft) performed as “V” engines (FIG. 3), “boxer” engines, “star” engines, “H” engines.

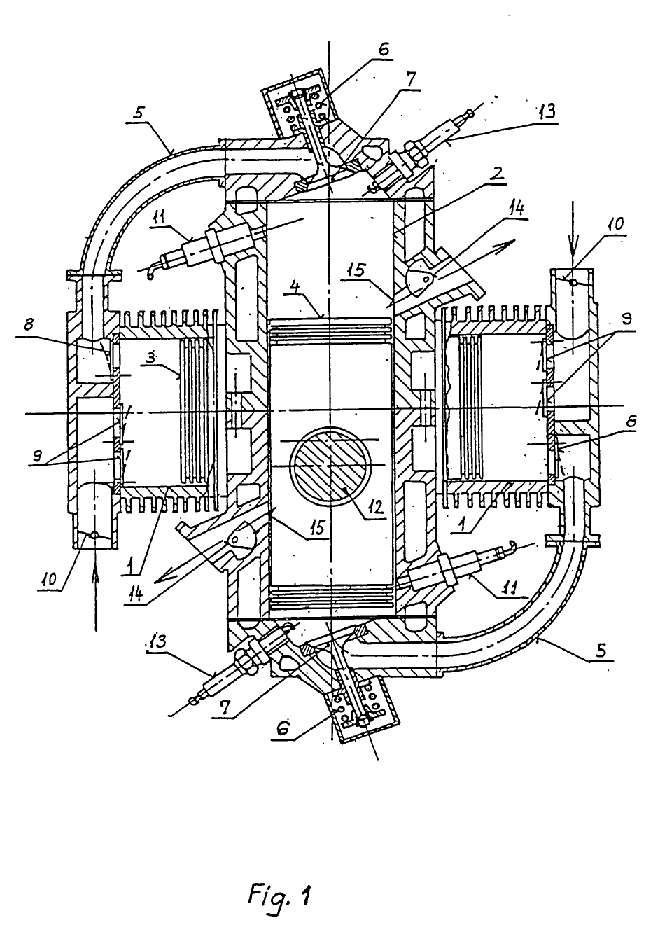

Engines with double pistons placed at an angle of 90 degrees to each other (FIG. 1).

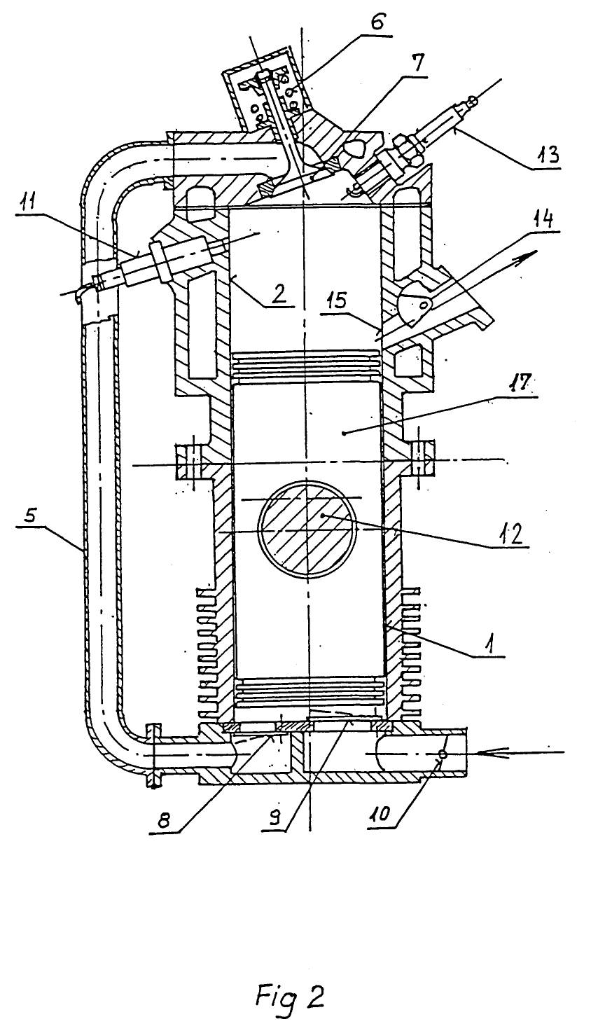

Engines with two-sided pistons (FIG. 2).

To resolve the problem means to improve the cycle of two-stroke engines.

### BACKGROUND ART

Two-stroke engine performances already existing:

Inlet regulation via a valve controled by the cam shaft, while exhaustion is enabled via a channel in the cylinder.

Cylinder charging and discharging regulation via a through-hole of the transverse scouring system, with the assistance of the deflecting piston's bottom.

Cylinder charging and discharging regulation via a through-hole in the cylinder and by means of the withdrawal scouring.

Cylinder charging and discharging regulation via a through-hole and by means of the one-way scouring with the double-cylinder applied.

Regulation of the exhaustion via a valve controled by the cam shaf, and inlet is provided via a through-hole in the cylinder.

Cylinder charging and discharging regulation via the valves controled by the cam shaft.

It should be mentioned that an installation of the rotative valve in every exhausting through-hole is possible.

### DISCLOSURE OF THE INVENTION

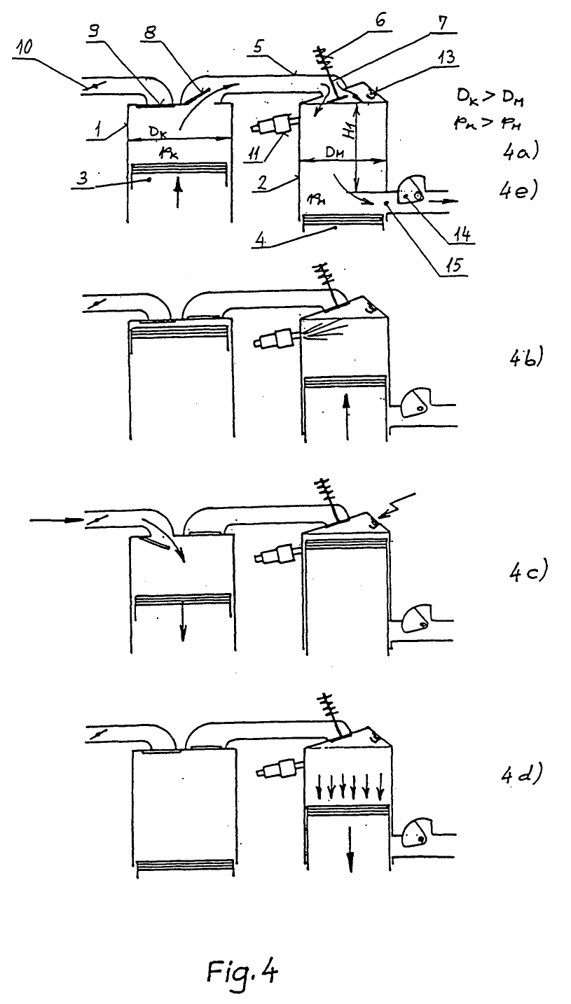

It is essential for the present invention that two cylinders work in yoke. One cylinder acts as compressor (pump) (1), while the other acts as engine (2). Pistons in the cylinders have the phase delay to each other in way that the compressor piston (3) is advanced with respect to the engine piston (4) as much as half of the stroke, meaning, when one of the pistons is in upper or in lower dead point (UDP or LDP), the other piston is in the midpoint between UDP and LDP, and vice-versa FIG. 4 shows entire two-stroke cycle scheme of the present invention, where the compressor cylinder (1) and the engine cylinder (2) are drawn near each other for the sake of simplicity. Every particular kind of engine performed according to the present invention is shown in FIGS. 1, 2, and 3. The very cycle elapses in one crankshaft revolution. FIG. 4a displays the moment when the compressor piston (3) is in its stroke midpoint, while the engine piston (4) is in the lower dead point (LDP). In this moment the compressor has precompressed the air, while combustion gas has almost entirely left the engine via the exhausting channel (15).

Because of the higher pressure in the compressor and in the compressing pipe (5) than in the engine, the pressure difference overcomes the spring (6) force and the valve (7) opens, as also the exhausting reed valve (8) of the compressor does, resulting the air to enter the engine cylinder (2). In that way the charging of the engine cylinder (2) with the fresh air is enabled, and also scouring out, by the excess of air, the rested combustion gas from that very cylinder; all this being possible because the diameter of the compressor cylinder (1) and the diameter of the engine cylinder (2) are different in such way that Dk>Dm (FIG. 4a). FIG. 4b shows the moment when the compressor piston (3) has reached the UDP and delivered to the engine all sucked air, while the engine piston (4) has passed the half of the stroke and is compressing the air-fuel compound because the exhausting channel (15) is overlaped and closed by the engine piston (4) and the injector (11) has injected the fuel into the cylinder (so the engine of the present invention has no fuel losses as the two-stroke engines of the prior art have). Now the pressure in the engine is exceeding the pressure in the compressing pipe (5) thus enabling the spring (6) to shut the valve (7). FIG. 4c shows the moment when the compressor piston (3) has passed the half of the stroke and is sucking the fresh air through the inlet reed valve (9), where the amount of that air is cotrolled by the throttle (10). At the same moment the engine piston (4) has reached the UDP and finished the compression of the air-fuel compound, and also the sparking plug (13) is starting the ignition. FIG. 4d shows the moment when the compressor piston (3) has reached the LDP and finished the sucking of the air, while the engine piston (4) has passed the half of the stroke driven by the combustion gas. FIG. 4e shows the compressor piston (3) compressing the air, while the engine piston (4) has reached the LDP. The combustion gas, assisted by the excess of air from the compressor, has gone to the atmosphere passing through recently opened exhausting channel (15) and through the rotative exhausting valve (14). The cycle is repeating.

Present Invention Advantages:

The difference between the compressor cylinder (1) diameter and the engine cylinder (2) diameter (Dk>Dm, from FIG. 4a) gives us the opportunity to charge the engine with the desired amount of the fresh air and to have the excess of air for scouring, what is not possible at the two-stroke engines of the prior art.

The expansion is longer because the exhausting channel (15) is positioned lower than it is possible to do at the two-stroke engines of the prior art. See H1 at FIG. 4a

By mutual coupling of several models it is easily possible to obtain multiline engines.

Description of the Drawings:

Meaning of the numbers at the FIGS. 1, 2, 3, and 4:

1. compressor (pump) cylinder

2. engine cylinder

3. compressor (pump) piston; two-sided piston at FIG. 1 and one-sided piston at FIG. 3

4. engine piston; two-sided piston at FIG. 1 and one-sided piston at FIG. 3

5. compressing pipe

6. spiral spring

7. inlet valve of the engine

8. exhausting reed valve of the compressor

9. inlet reed valve of the compressor

10. throttle

11. injector

12. crankshaft

13. sparking plug

14. rotative exhausting valve

15. through-hole (channel) in the engine cylinder

16. rod

17. two-sided piston (engine-compressor)

ONE of the inventive engine designs:

FIG. 1 shows two-cylinder “X” engine with two two-sided pistons. One piston acts as the compressor piston (3), and other acts as the engine piston (4), while the compressor and engine chambers are connected with each other via compressing pipe (5). For the strain is not high, the compressor valves (8) and (9) are performed as reed ones, while the inlet valve (7) of the engine, which suffers more strain, is performed as standard one. In the exhausting channel of the engine cylinder, the rotative valve is installed for better engine functioning.

1. Two-stroke cycle for internal combustion engines applicable to classical engines (piston-rod-crankshaft) such as “V” engines (FIG. 3), line engines, “boxer” engines, “star” engines, “H” engines, also applicable to engines with two-sided piston (FIGS. 1 and 2), housing at least one pair of cylinders, of which one acts as compressor (pump) and other as engine, with pssibility for mutual coupling of several pairs to obtain multiline engines, invention being, characterized in that, the engine has at least the one pair of cylinders of which one is the compressor (pump) cylinder (1) and other is the engine cylinder (2), wherein each cylinder houses one piston, which pistons have phase delay to each other in way that when one of the pistons is in one of the dead points (LDP or UDP), the other one is in the midpoint (between LDP and UDP) and vice-versa, also being characterized in that the compressor cylinders (1) are connected with the engine cylinders (2) via compressing pipe (5), and in that compressor (1) has inlet reed valves (9) and exhausting reed valves (8), while engine (2) has inlet valve (7) which is opened by the pressure difference between the compressing pipe (5) and engine chamber (2) or closed by the spring (6) force when pressure difference becomes zero, and also has the exhausting channel (15) which cmprises the exhausting rotative valve (14), also being characterized in that the compressor cylinder (1) diameter “Dk” is larger than the engine cylinder (2) diameter “Dm” is, also being characterized in that with mutual coupling of several pairs of cylinders the multiline engines can be obtained, which engines can be gasoline, Diesel, or gas consuming, and finally in that this two-stroke cycle is applicable at classical internl combustion engines (piston-rod-crankshaft), and at internal combustion engines with two-sided pistons positioned at 90 degrees to each other or with two-sided pistons positioned in the parallel.
